(19) United States
(12) Patent Application Publication
(10) Pub. No.: US 2021/0039766 A1
(43) Pub. Date: Feb. 11, 2021

(54) World Airway Safety

(71) Applicant: Mohammad Najeeb Nazhand, Sacramento, CA (US)

(72) Inventor: Mohammad Najeeb Nazhand, Sacramento, CA (US)

(21) Appl. No.: 16/531,120

(22) Filed: Aug. 5, 2019

(51) Int. Cl. B64C 1/32; B64D 17/80; B64D 25/18

(52) U.S. Cl. CPC B64C 1/32; B64D 25/18; B64D 17/80

(57) ABSTRACT

The present invention discloses a rescue solution for the passengers of a plane. When the plane is in emergency situation the passengers proceed to a safety room and parachute will be activated as the passengers leave the rear of the plane. The passengers will slowly ascend to earth safely.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

This invention relates generally to airplane safety and emergency systems and methods and, more specifically, to an evacuation system and method comprising an evacuation safety room in back side of airplane by dropping luggage to have enough vacant space to adjust passengers this section will detach from the plane in emergency.

### Description of the Related Art

The safety of airplane passengers has been a concern from the beginning of aviation. Planes crash for a variety of reasons, including pilot error, mechanical error, weather, etc. Often, it is the case that the pilot is aware that his or her plane is in trouble and is going to crash or is in danger of crashing. However, in many such cases, there is little the pilot can do to ensure his or her safety as well as the safety of the passengers.

One of today's greatest airline concerns is airplane safety. This concern is due to a high number of airplane crashes in the recent past. Although these crashes have many different causes, the result usually ends in loss of life. Due to the major effect that these crashes have of the general public, the public's safety and well being has become more important as each crash occurs.

A need therefore existed for an evacuation system utilizing an evacuation cabin, mounted in a back portion of an airplane, and deployable in the event of an emergency. The cabin should be equipped with one or more parachutes, to permit a landing at a safe velocity. Other emergency-type equipment, including a radio, parachutists, chargeable battery, computerized control and operating systems, cameras and the like should also be provided, to ensure prompt location of the cabin and the rescue of its occupants. The present invention satisfies these needs and provides other, related advantages.

Known technical solution (Patent RU N 2021164, B 64 C 1/32, 1994) on Airbus, wherein the fuselage consists of several parts by the number of sections of the passenger compartment which is integrally attached to the respective sections of the cabin, wherein the adjacent sections are provided with means for separating the from each other and sealing devices, and means for separating the interior sections of the wings and the tail part are formed as explosive bolts.

Known technical solution (Patent RU N 2045858, B 64 C 1/32, 1996) on a passenger aircraft with rescue modules which comprises a passenger compartment in which is located at least one rescue unit, which compartment the cabin, with this is one of its side wall forms the outer perimeter of the fuselage, it is an element of the power circuit, and another side wall facing the central aisle of the aircraft and is provided with an airtight door.

The main drawback of the above technical solutions are modular-section of the fuselage design, which reduces its rigidity and adversely affect the safety of aircraft operation.

None of the previous inventions and patents, taken either singly or in combination, is seen to describe the instant invention as claimed. Hence, the inventor of the present invention proposes to resolve and surmount existent technical difficulties to eliminate the aforementioned shortcomings of the prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary desirable object of the present invention is to provide a novel and improved way to expand the range of emergency situations of the aircraft in which it becomes a real rescue of passengers and to save human life.

It is another objective of the invention to provide technology which will be separated rescue capsule from parts aircraft, the parachute opens,

One object of the present invention, therefore, is to provide an improved form of flight capsule designed for ejection from an aircraft traveling at sonic or supersonic speeds.

Another object of the invention is to provide emergency evacuation system that functions rapidly in order to minimize the time required for evacuating passengers from the aircraft.

It is another objective of the invention to provide safety room in back side of airplane which is a luggage area and in-case of need the luggage could be dropped from the plane and same area could be used for saving passengers life.

It is further the objective of the invention that the safety room will have enough security components in-case of landing at water to avoid drowning in water.

It is an object of the invention to provide an improved, simple and inexpensive capsule which is realistic and could easily be deployed.

This summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 100 is an exemplary of the plane and safety compartment.

FIG. 200 shows safety room when deployed.

FIG. 300 shows the interior view of the safety room.

FIG. 400 shows side view of the safety room.

FIG. 500 shows and Bendable Wings.

FIG. 600 shows the safety room and a step motor.

FIG. 700 shows safety room attached to drones.

FIG. 800 shows the overall view of the invention when in full use.

FIG. 900 shows the inside view of the plane.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

One aspect of the present application is directed to an inflight airplane which is facing emergency, the operator first close the air control door between safety room and airplane, then drop luggage and kitchen outside of the airplane to the ground from the backside airplane, to have enough empty space for the safety room to adjust all passengers.

As per preferred embodiment of the invention, the In-Flight Evacuation System will be an automatic functioning system. The system will be timed to ensure the minimum amount of time needed to evacuate all passengers and crew from the airplane. The system will have two sources of power; one being supplied by the electrical system of the plane and the other being a backup battery powered system. A battery powered system will be used in case of loss of power by the airplane.

As per preferred embodiment of the invention, the safety room will have:

1—Safety room ceiling and wall materials fire rated aluminum
2—Drone system

### 3—Bendable Wings

### 4—Parachutists

5—Chargeable battery
6—Computerized control and operating systems

### 7—Cameras

8—Temperature control system (outside and inside sensors with automatic operating system)
9—Installation of safety room tight closing inside of the airplane and running or moving system in the steel rail road system
10—Dropping off Safety room method and ground moving technology
11—Inside of safety room we have oxygen inside—seat belt—handrail—operator seat and operating technology to control the safety Room
12—Hydraulic legs technology: If the landing area is Mountains, the operator will open the steel hydraulic legs of safety box to ageist the level of safety box, no drop,
13—Airbag technology: if operator seen the landing area is water, he will open the airbag at the bottom of the safety room to avoid drowning in water
14—Inside Airbag technology: we have airbag technology at the inside of safety room to keep save passengers at the safety Room.

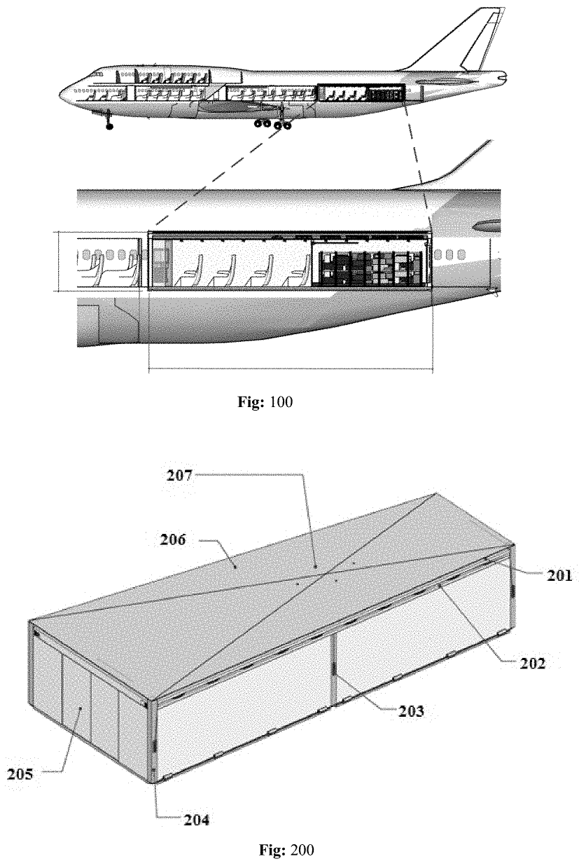

FIG. 100 shows the safety room and the area which would be used to serve the purpose within a normal airplane. The desired area would be primarily the luggage storage area and some of the seating area.

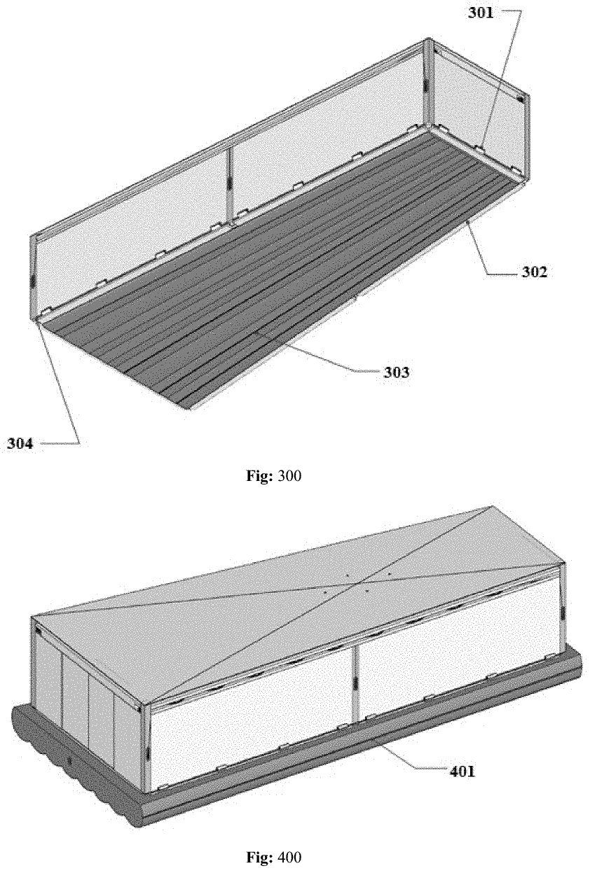

FIG. 200 shows the top overall structure of the safety room. The safety room will have wings and parachutes layer 201. An area for affixing drone 202. There will be cable rail for the steel rope 203 and the four sides will have piston rods inside 204. There is a sliding door 205 for entry and exit of passengers. There is a removable ceiling 206 and steel rope connection holes 207.

FIG. 300 shows the bottom structure of the safety room. 301 shows locking system for lower door of the safety room. Then there is lower door 302 for dropping items when in emergency. After freefalling there are air pads for water area 303. There are also piston rodes 304 for the ground area after freefalling.

FIG. 400 shows the overall design of the safety room with airpads 401.

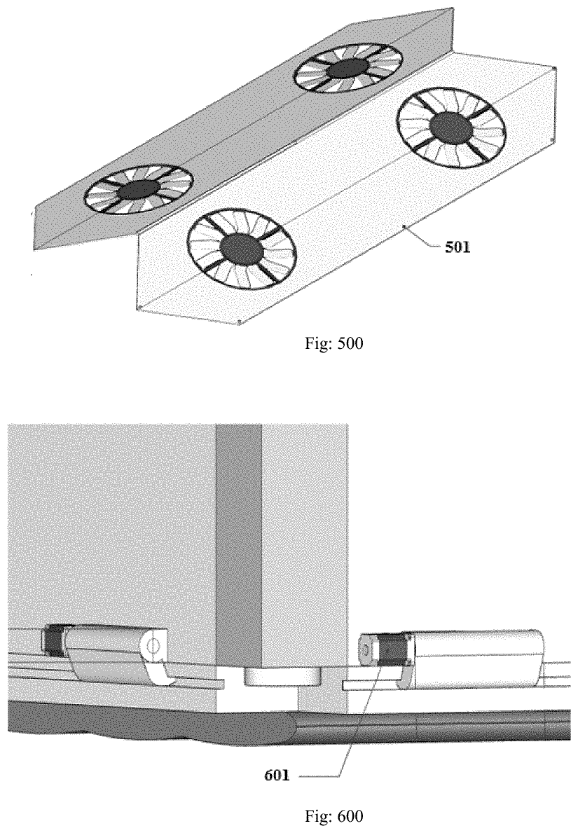

FIG. 500 shows the drones and Bendable Wings 501.

FIG. 600 shows the bottom assembly of the safety room and a step motor 601.

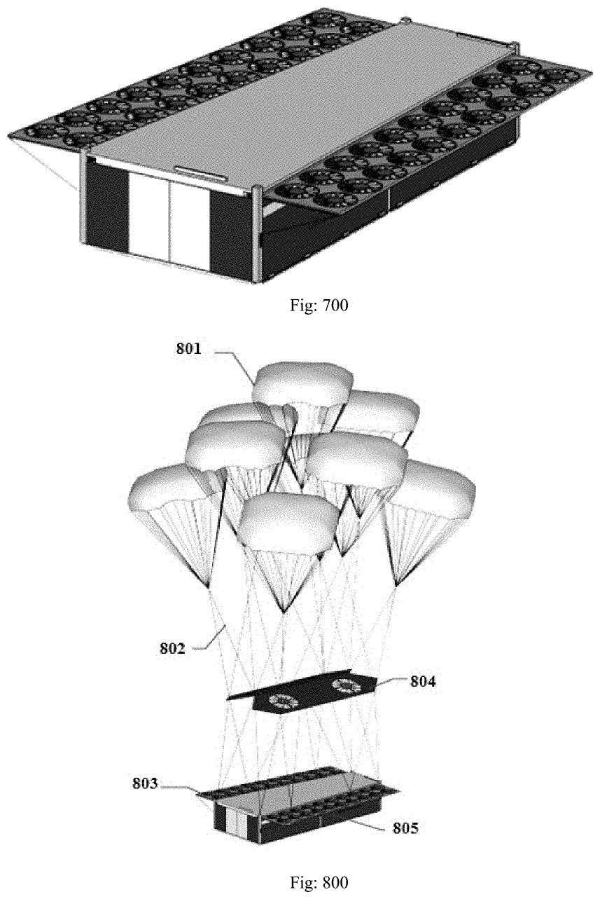

FIG. 700 show the safety room attached to drones operational in-case of emergency.

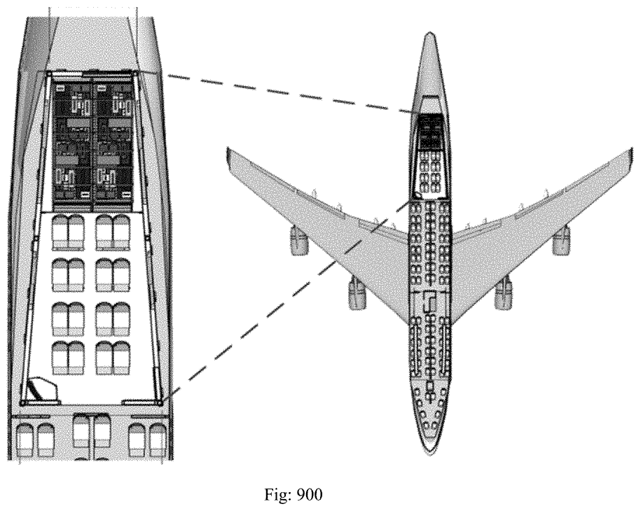

FIG. 800 shows the overall view of the invention when in full use. On the top parachutes 801 are shown which will help in safe landing.

FIG. 900 shows inside view of the plane and safety room.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

I: An in-flight evacuation system comprising:
a) an aircraft having safety room existing luggage area and kitchen area of an airplane which can be used for passengers in-case of emergency;
b) detachably coupling said safety room from said airplane;
c) releasing of said safety room; and opening said at least one parachute.

II: Safety room comprises of:
a) Safety room ceiling and wall materials fire rated aluminum;
b) Drone system;
c) Bendable Wings;
d) parachutists;
e) chargeable battery;
f) computerized control and operating systems;
g) Cameras;
h) Temperature control system (outside and inside sensors with automatic operating system);
i) Installation of safety room tight closing inside of the airplane and running or moving system in the steel rail road system;
j) Dropping off Safety room method and ground moving technology;
k) Inside of safety room is oxygen inside—seat belt—handrail—operator seat and operating technology to control the safety Room;
l) Hydraulic legs technology: If the landing area is Mountains, the operator will open the steel hydraulic legs of safety box to ageist the level of safety box, no drop;
m) Airbag technology: if operator seen the landing area is water, he will open the airbag at the bottom of the safety room to avoid drowning in water;
n) Inside Airbag technology to keep passengers safe at the safety Room.

III: The Safety room comprises of a flotation device incase of emergency landing on the water.
